(19) United States
(12) Patent Application Publication
(10) Pub. No.: US 2024/0292820 A1
(43) Pub. Date: Sep. 5, 2024

(54) Lure Device

(71) Applicant: Brian Eugene Branum, Jasper, TX (US)

(72) Inventor: Brian Eugene Branum, Jasper, TX (US)

(21) Appl. No.: 18/662,803

(22) Filed: May 13, 2024

Related U.S. Application Data
(63) Continuation-in-part of application No. 17/438,875, filed on Sep. 13, 2021.
(60) Provisional application No. 62/817,698, filed on Mar. 13, 2019.

(51) Int. Cl. A01K 83/06

(52) U.S. Cl. CPC A01K 83/06

(57) ABSTRACT

An attachment device for coupling a fishing hook to a fishing lure is provided. The attachment device may include a coupling member configured to couple with the fishing hook. The attachment device may also include an embedding member coupled to the coupling member. The embedding member may include two or more helical coils that are integrated into a multi-helical configuration and that are configured to couple the embedding member to the fishing lure.

### CROSS-REFERENCE TO RELATED APPLICATIONS

This patent application is a Continuation-In-Part application of U.S. patent application Ser. No. 17/438,875, filed on 13 Sep. 2021 and entitled “Lure Device”, which claims the benefit of the filing date of the PCT Application Serial No. PCT/US2020/022820, filed on 13 Mar. 2020 which claims the benefit of the filing date of the U.S. Provisional Patent Application Ser. No. 62/817,698, filed on 13 Mar. 2019 and entitled “Lure Device,” the entire content of each are hereby expressly incorporated by reference.

### STATEMENT REGARDING FEDERALLY SPONSORED RESEARCH OR DEVELOPMENT

Not applicable.

### BACKGROUND

This disclosure relates in general to fishing equipment and in particular to apparatuses and systems for attaching a fishing lure to a fishing hook and/or a fishing line.

For successful fishing, a fisherman should identify, on any particular day, the type of bait that attracts fish. A fisherman may attach several different fishing hooks and/or fishing lures to a fishing line before identifying which combination of fishing hooks and fishing lures is attractive to the fish. A fisherman may encounter difficulty using current devices for attaching fishing hooks, fishing lures, and/or fishing lines together. These current devices may also break easily, cause unnecessary damage to the fishing lure, and give the fishing lure unnatural movement that deters fish when the fishing lure moves through the water.

### BRIEF DESCRIPTION OF THE DRAWINGS

FIGS. 1 and 2 are oblique views of an example embodiment of an attachment device according to this disclosure.

FIG. 3 is an oblique view of an example embodiment of a fishing lure coupling system according to this disclosure.

FIG. 4 is another oblique view of an example embodiment of the fishing lure coupling system illustrated in FIG. 3.

FIG. 5 is an oblique view of an example embodiment of a fishing lure system according to this disclosure.

FIG. 6 is an oblique view of another example embodiment of a fishing lure system according to this disclosure.

FIGS. 7 and 8 are oblique views of other example embodiments of fishing lure systems according to this disclosure.

FIG. 9 is an orthogonal view of an alternative embodiment of an attachment device.

FIG. 10 is an orthogonal view of another alternative embodiment of an attachment device.

FIG. 11 is an orthogonal view of another alternative embodiment of an attachment devices.

FIG. 12 is another orthogonal view of the attachment device of FIG. 11.

FIG. 13 is another orthogonal view of the attachment device of FIG. 11.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, systems, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

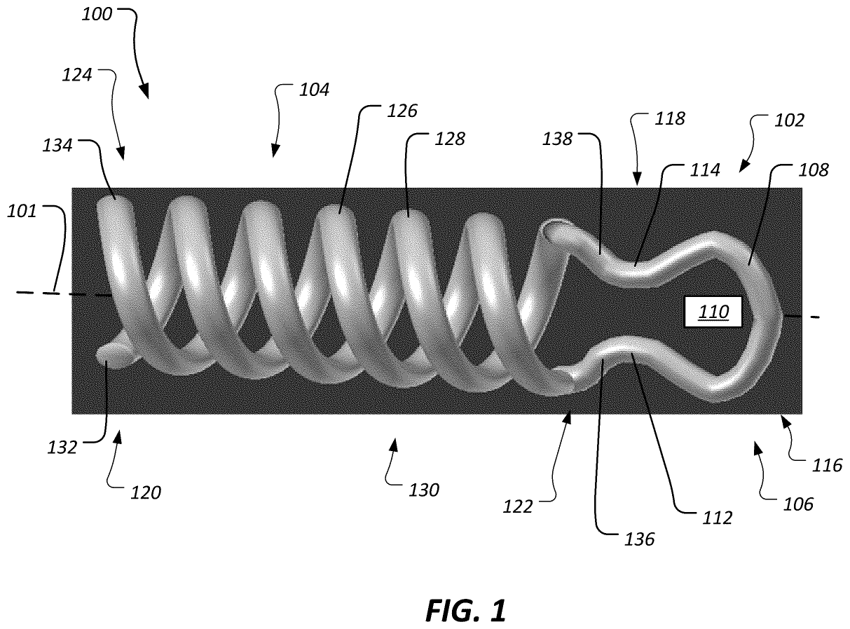

FIG. 1 is an oblique view of an example embodiment of an attachment device 100 according to this disclosure. Attachment device 100 can be used for attaching a fishing lure, fishing line, and/or a fishing hook together. Attachment device 100 generally comprises a coupling member 102 and an embedding member 104. Coupling member 102 may be positioned at distal end 106 of attachment device 100 and may couple attachment device 100 to a fishing hook and/or a fishing line. As shown in FIG. 1, coupling member 102 may include loop 108, a space or through-hole 110 at least partially defined by the loop 8, first transition member 112, and second transition member 114.

Loop 108 may be positioned at distal end 116 of coupling member 102. Through-hole 110 (e.g., an opening or an eyelet) may be formed by loop 108, as shown in FIG. 1. Loop 108 and through-hole 110 may be configured to receive and secure a fishing hook and/or a fishing line to coupling member 102. For example, through-hole 110 may be sized and shaped to receive an end of a fishing hook. The end of the fishing hook may, for example, form an eyelet, a hook, a loop, or the like. After through-hole 110 receives the end of the fishing hook, loop 108 may be sized and shaped to permit the end of the fishing hook to couple with or wrap around loop 108 for securing the fishing hook to coupling member 102. Loop 108 and through-hole 110 may also be sized and shaped so that when a fishing hook is coupled to coupling member 102, an orientation of the fishing hook may be adjusted relative to attachment device 100. Loop 108 and through-hole 110 may be sized and shaped to additionally receive a fishing line for securing the fishing line to coupling member 102 in a same or similar manner. In some embodiments, through-hole 110 may be sized and shaped to receive only a fishing line for securing the fishing line to coupling member 102.

In some embodiments, through-hole 110 may have a circular shape, as shown in FIG. 1. Alternatively, through-hole 110 may have an ellipsoidal shape, a triangular shape, a quadrilateral shape, a hexagonal shape, an octagonal shape, an eyelet shape, or any other suitable shape. A person having ordinary skill in the art would be able to determine, without undue experimentation, various sizes and shapes suitable for through-hole 110 described herein. As an alternative to through-hole 110 being formed by loop 108, through-hole 110 may be formed by creating a perforation that extends through a sheet of material (e.g., metal and/or plastic).

First transition member 112 and second transition member 114 may be positioned at proximal end 118 of coupling member 102 and may each be configured to couple coupling member 102 to embedding member 104. As shown in FIG. 1, first transition member 112 and second transition member 114 may each extend from loop 108 to couple coupling member 102 to embedding member 104. In some embodiments, loop 108, first transition member 112, and second transition member 114 may be formed by one or more strips of material, described herein. Alternatively, coupling member 102 may be formed using a sheet of material (e.g., metal and/or plastic) having at least one perforation extending therethrough.

Embedding member 104 may be positioned at proximal end 120 of attachment device 100 and may couple attachment device 100 to a fishing lure, such as a flesh-like or malleable fishing lure. Embedding member 104 may include two or more helical coils that each extend at least partially between distal end 122 of embedding member 104 and proximal end 124 of embedding member 104. Each helical coil may be integrated or arranged with each other forming a multi-helix configuration. A multi-helix configuration may be two or more substantially parallel helices intertwined about a common central axis 101. A multi-helix configuration may limit or reduce lateral translation of embedding member 104, for example, during rotational penetration into a fishing lure. A multi-helix configuration may additionally, or alternatively, reduce a distance that the embedding member 104 penetrates into a fishing lure to securely fasten the fishing lure to attachment device 100. As shown in FIG. 1, embedding member 104 may include first helical coil 126 and second helical coil 128 that are integrated or arranged with each other forming double-helix configuration 130 about central axis 101.

Each helical coil of embedding member 104 may be formed using a strip of material, described herein, that is wound into a helical configuration. Each helical coil may have a longitudinal distance, defined by a distance that the helical coil extends along a longitudinal axis of the helical coil through a 360-degree turn, that may be used to define a slope of the helical coil. Each helical coil may have a slope that is between, but may not include, zero slope and no slope. Each helical coil may also have a radius, defined by a distance between a strip of material forming the helical coil and a longitudinal central axis of the helical coil, that may be used to define a curvature of the helical coil.

In some embodiments, a helical coil may have a constant slope and/or a constant curvature forming, for example, a right circular cylindrical shape. A helical coil may additionally, or alternatively, have a change in slope (e.g., a varying slope). Additionally, or alternatively, a helical coil may include a change in curvature (e.g., varying curvature) forming, for example, an elliptic cylindrical shape, a parabolic cylindrical shape, a hyperbolic cylindrical shape, a combination thereof, or the like. A multi-helix configuration may include at least two helical coils having a different curvature and/or a different slope. A multi-helix configuration may include at least two helical coils having a different varying curvature and/or a different varying slope. Additionally, or alternatively, a multi-helix configuration may include at least two helical coils having a same curvature and/or a same slope. As shown in FIG. 1, first helical coil 126 and second helical coil 128 in double-helix configuration 130 may have a same curvature and a same slope forming a right circular cylindrical shape.

Embedding member 104 may be configured to fasten a fishing lure, such as a flesh-like or malleable fishing lure, to attachment device 100. However, prior to attaching the attachment device 100 to a fishing lure, the attachment device 100 can be attached to an eyelet of a fishing hook. In some cases, an end member such as an end member 132 or an end member 134 can be fed through the fishing hook eyelet and the attachment device 100 can be rotated about central axis 101 to advance an increasing amount of the attachment device 100 through the fishing hook eyelet. Such advancement can be discontinued once a portion of the loop member 108 is disposed within the fishing hook eyelet. Once the attachment device 100 is joined to the fishing hook eyelet in the manner described above, first and second helical coils 126 and 128 may engage with a surface of a fishing lure and be rotated in a first direction about the axis 101 causing an end member 132 of first helical coil 126 and an end member 134 of second helical coil 128 to penetrate or pierce into or through the fishing lure. End members 132 and 134 may penetrate or pierce into or through a fishing lure at an angle with a surface of the fishing lure that correlates with a slope of first helical coil 126 and second helical coil 128, respectively. The angle may be between, but may not include, an angle that is parallel with the surface of the fishing lure and an angle that is perpendicular to the surface of the fishing lure.

As first and second helical coils 126 and 128 rotate and the end members 132 and 134 of first and second helical coils 126 and 128, respectively, penetrate into the fishing lure, first and second helical coil 126 and 128 may rotate and advance into or through the fishing lure in a direction parallel to longitudinal axes of first and second helical coils 126 and 128 and/or perpendicular to the surface of the fishing lure. Once first and second helical coils 126 and 128 are at least partially within the fishing lure, a slope of first and second helical coils 126 and 128 may secure first and second helical coils 126 and 128 within the fishing lure when first and second helical coils 126 and 128 receive tension in a direction perpendicular to the surface of the fishing lure and/or parallel to their longitudinal axes, such as axis 101. Thus, first and second helical coils 126 and 128 may engage with and penetrate into or through a fishing lure for fastening the fishing lure to attachment device 100.

In some embodiments, end members 132 and 134 may merely include an end of first helical coil 126 and an end of second helical 128. Alternatively, end members 132 and 134 may include a point or a sharp edge at ends of first and second helical coils 126 and 128. End members 132 and 134 may additional, or alternatively, include one or more barbs or stoppers configured to permit first and second helical coils 126 and 128 to penetrate into or through a fishing lure while inhibiting first and second helical coils 126 and 128 from being removed from within the fishing lure.

In addition to embedding member 104 being configured to fasten a fishing lure to attachment device 100, embedding member 104 may also be configured to decouple the fishing lure from attachment device 100. For example, after lure coupling device 104 has fastened the fishing lure to attachment device 100, first and second helical coils 126 and 128 may be rotated in a second direction, opposite the first direction, causing first and second helical coils 126 and 128 to advance through and out of the fishing lure in a direction parallel to their longitudinal axes and/or perpendicular to the surface of the fishing lure. Rotating first and second helical coils 126 and 128 in the second direction may circumvent the ability of first and second helical coils 126 and 128 to resist movement in a longitudinal, axial direction, for example, because of their slopes, out of the fishing lure. Thus, first and second helical coils 126 and 128 may be rotated in the second direction and advanced through and out of the fishing lure to decouple the fishing lure from attachment device 100.

Embedding member 104 may further include a connection member positioned at distal end 122 of embedding member 104. A connection member may couple embedding member 104 to coupling member 102. As shown in FIG. 1, connection member 136 may be formed at an end of first helical coil 126 and may link first helical coil 126 with first transition member 112 of coupling member 102. Similarly, connection member 138 may be formed at an end of second helical coil 128 and may link second helical coil 128 with second transition member 114 of coupling member 102.

Attachment device 100 and/or components thereof may by formed by one or more strips of material. A strip of material may be an elongated piece of material, such as a wire, having a circular cross-sectional shape and including a plastic and/or a metal. Additionally, or alternatively, a strip of material may be an elongated piece of material, such as a wire, having at least one of an ellipsoidal cross-sectional shape, a triangular cross-sectional shape, a quadrilateral cross-sectional shape, a hexagonal cross-sectional shape, an octagonal cross-sectional shape, or the like and including a plastic and/or a metal. A thickness or a diameter of a cross-sectional area of a strip of material may include, for example, a dimension between about 0.0005 inches and about 0.0625 inches. A person having ordinary skill in the art would be able to determine, without undue experimentation, various materials, cross-sectional shapes, and thickness suitable for forming attachment device 100 and/or components thereof, described herein.

Attachment device 100 may be formed by a single strip of material. Thus, sections of the single strip of material may be molded or shaped to form components of the attachment device 100. As shown in FIG. 1, a single strip of material forms end member 132, first helical coil 126, connection member 136, first transition member 112, loop 108, second transition member 114, connection member 138, second helical coil 128, and end member 134.

Alternatively, components of attachment device 100 may be formed from separate individual strips of material, described herein, and may be coupled together using a joining process, such as welding, brazing, soldering, riveting, sintering, pressing, or the like. For example, embedding member 104 and coupling member 102 may be formed from separate strips of material. Connection members 136 and 138 may be coupled, using a joining process, to first and second transition members 112 and 114, respectively, for coupling embedding member 104 to coupling member 102. As another example, loop 108, first transition member 112, and second transition member 114 may each be formed from separate strips of material. Loop 108, first transition member 112, and second transition member 114 may be coupled together, using a joining process, to form coupling member 102. As yet another example, connection member 136 and first helical coil 126 may be formed from separate strips of material and may be coupled together, using a joining process, to form at least a portion of embedding member 104.

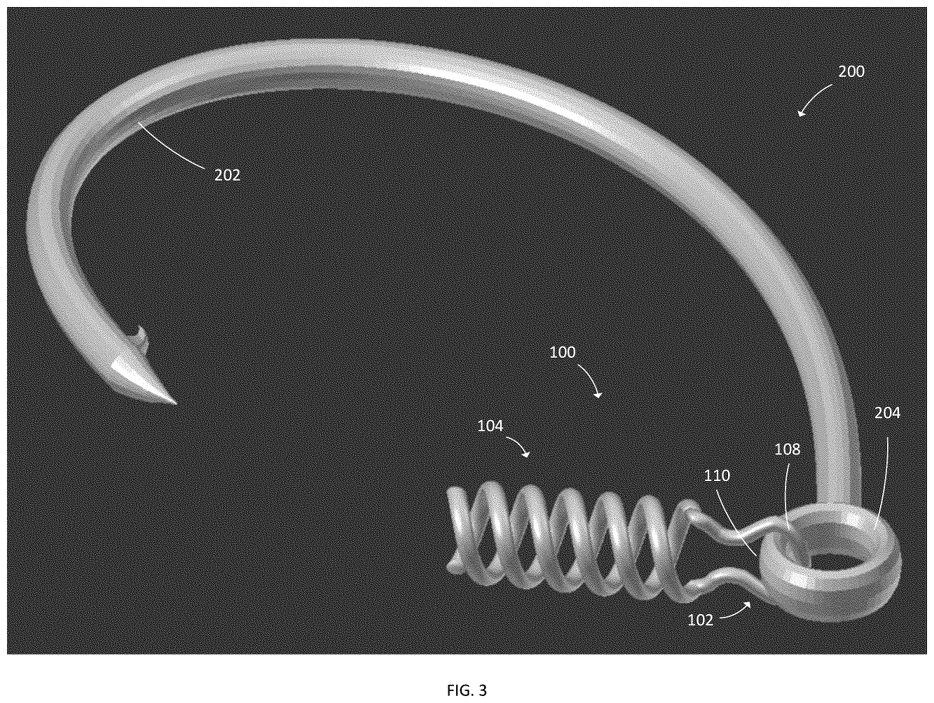

FIG. 3 is an oblique view of an example embodiment of a fishing lure coupling system 200 according to this disclosure. Fishing lure coupling system 200 may generally include attachment device 100 and fishing hook 202. In some embodiments, fishing lure coupling system 200 may include a fishing line in addition to fishing hook 202 or may include a fishing line in lieu of fishing hook 202. Fishing lure coupling system 200 may include attachment device 100 coupled to fishing hook 202 for use with a fishing lure.

As shown in FIG. 3, attachment device 100 may include coupling member 102 that has received and secured fishing hook 202 to fishing lure coupling system 200. Coupling member 102 may be coupling attachment device 100 to fishing hook 202 using loop 108 and/or through-hole 110, described herein. In addition, attachment device 100 may include embedding member 104, as shown. Lure couple member 104 may include two or more helical coils integrated into a multi-helix configuration, as described herein, to fasten a fishing lure to the fishing lure coupling system 200.

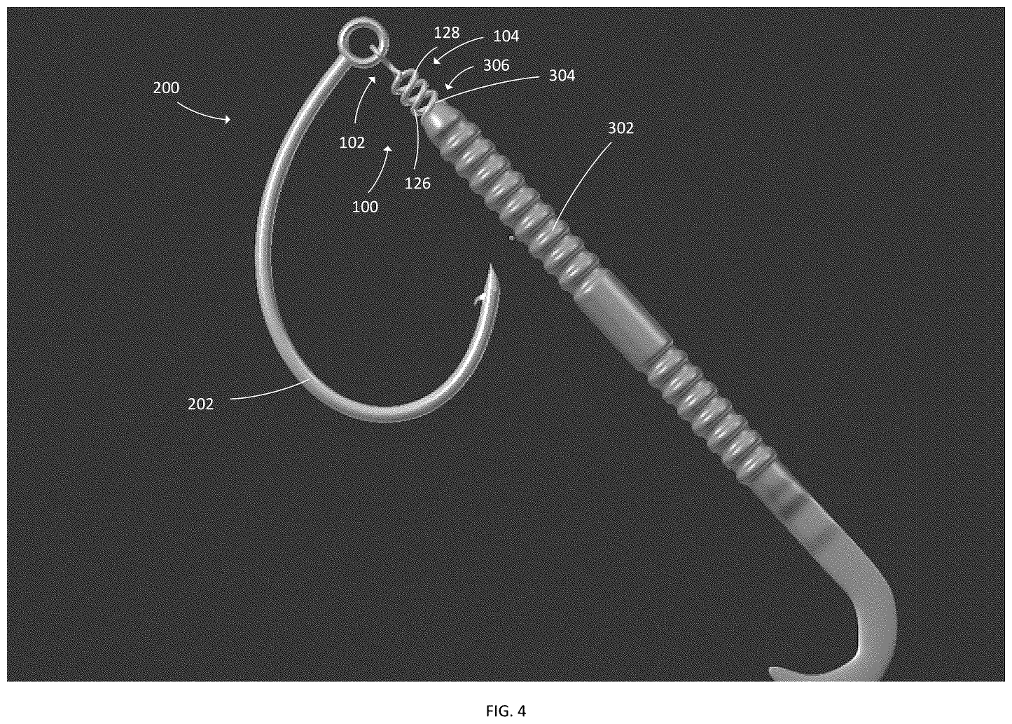

FIG. 4 is another oblique view of an example embodiment of fishing lure coupling system 200 illustrated in FIG. 3. As shown in FIG. 4, fishing lure coupling system 200 may be coupling with fishing lure 302. For example, embedding member 104 may be engaged with a surface 304 at a distal end 306 of fishing lure 302. First and second helical coils 126 and 128 of embedding member 104 may be rotated in a first direction causing first and second helical coils 126 and 128 to penetrate through surface 304 and into fishing lure 302, as described herein. When first and second helical coils 126 and 128 are at least partially within fishing lure 302, fishing lure 302 may be securely coupled or fastened to fishing lure coupling system 200. In addition, when first and second helical coils 126 and 128 are at least partially within fishing lure 302, fishing lure 302 may be decoupled from fishing lure coupling system 200 by rotating first and second helical coils 126 and 128 in a second direction, opposite the first direction, as described herein.

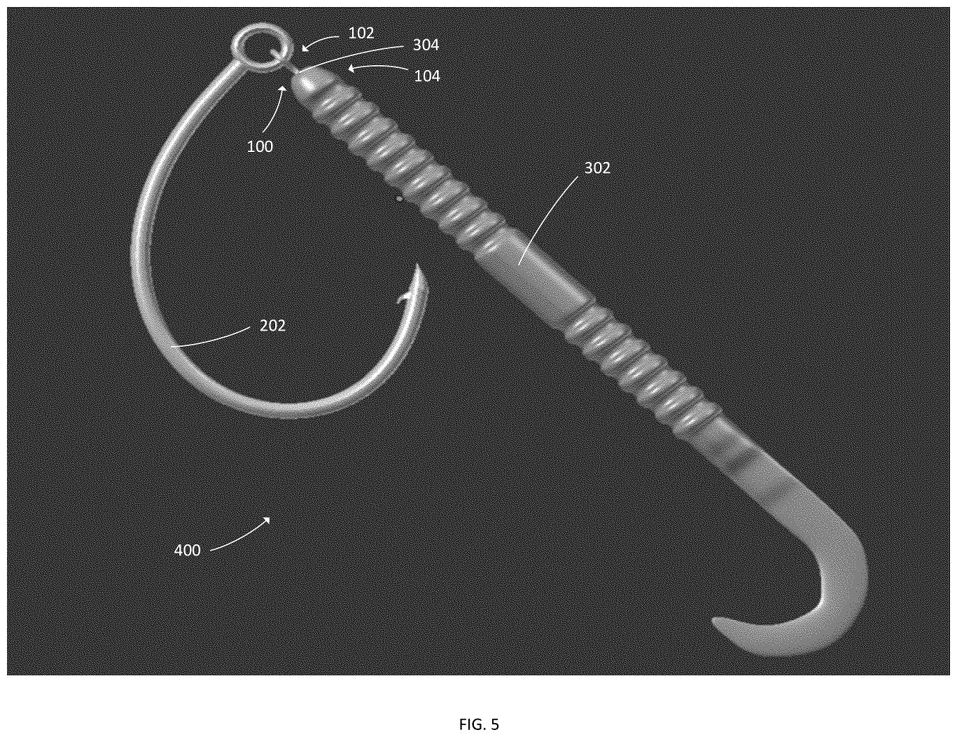

FIG. 5 is an oblique view of an example embodiment of a fishing lure system 400 according to this disclosure. Fishing lure system 400 may generally include attachment device 100, fishing hook 202, and fishing lure 302. In some embodiments, fishing lure system 400 may include a fishing line in addition to fishing hook 202 or may include a fishing line in lieu of fishing hook 202. Fishing lure system 400 may include fishing hook 202 coupled to fishing lure 302 using attachment device 100.

As shown in FIG. 5, attachment device 100 may include coupling member 102 that has received and secured fishing hook 202 to fishing lure system 400. Coupling member 102 may be coupling attachment device 100 to fishing hook 202 using loop 108 and/or through-hole 110, described herein. In addition, attachment device 100 may include embedding member 104, as shown. Lure couple member 104 may be coupling attachment device 100 to fishing lure 302 using two or more helical coils integrated into a multi-helix configuration, as described herein. In use, fishing lure system 400 may be tied to a fishing line for fishing.

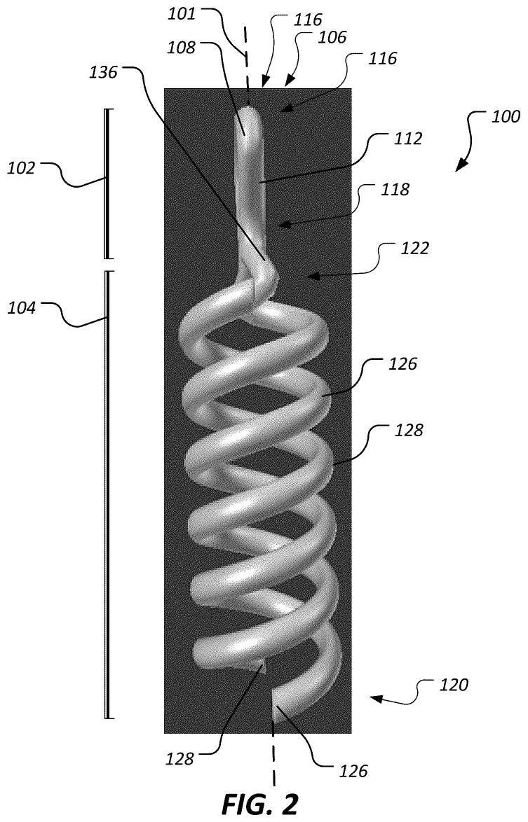

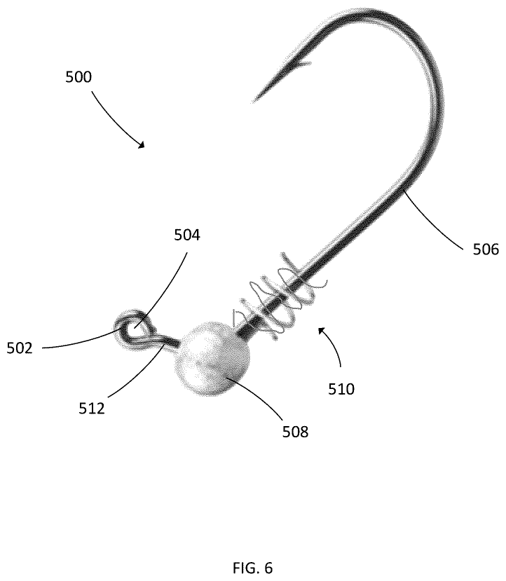

FIG. 6 is an oblique view of an example embodiment of another fishing lure system 500 according to this disclosure. Fishing lure system 500 may generally include loop 502 forming through-hole 504, fishing hook 506, molded material 508, and retainer 510. Loop 502 and through-hole 504 may be the same as or at least similar to loop 108 and through-hole 110, respectively, described herein. Fishing hook 506 may be the same as or at least similar to fishing hook 202 described herein. Retainer 510 may include two or more helical coils integrated or arranged together into a multi-helix configuration. The two or more helical coils integrated or arranged together into the multi-helix configuration of retainer 510 may be the same as or at least similar to the two or more helical coils integrated and arranged into the multi-helix configuration described herein with respect to FIGS. 1-5. Retainer 510 may be configured to support fishing hook 506 and/or molded material 508 for display.

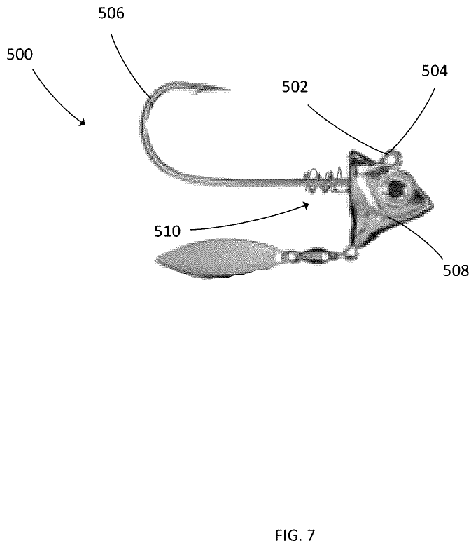

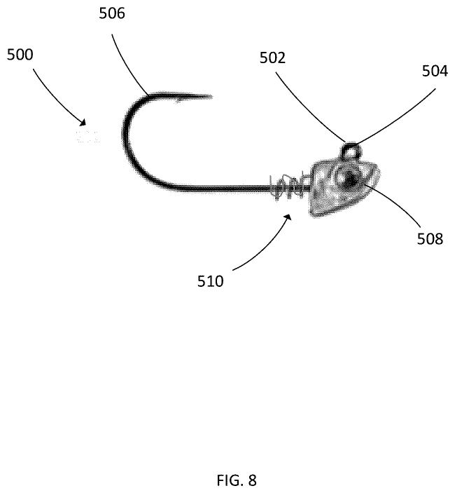

Molded material 508 may include a substance that was poured into a mold and cured or a substance that has hardened. Molded material 508 may include a plastic and/or lead. Molded material 508 may be configured to securely hold loop 502, through-hole 504, fishing hook 506, and retainer 510 together. Molded material 508 may have a generally spherical shape, as shown in FIG. 5. Alternatively, molded material 508 may have a lure shape, such as a shape of a fish or a shape of a fish head. FIGS. 7 and 8 are oblique views of other example embodiments of fishing lure system 500 with molded material 508 having lure shapes.

As shown in FIG. 6, loop 502 forming through-hole 504, fishing hook 506, and retainer 510 may all be secured to each other through molded material 508. Loop 502 may be coupled to molded material 508 using an extension member 512. Fishing hook 506 and retainer 510 may be coupled to molded material 508 at an end of each of fishing hook 506 and retainer 510. As shown in FIG. 6, fishing hook 506 may be coupled to molded material 508 by extending through and along an axis of the two or more helical coils of retainer 510. In some embodiments, loop 502 forming through-hole 504, fishing hook 506, and retainer 510 may be integrated with the substance used to form molded material 508 before hardening. Thus, when the substance forming the molded material 508 hardens, a portion of each of loop 502 forming through-hole 504, fishing hook 506, and retainer 510 may be encased within molded material 508 to secure each of loop 502 forming through-hole 504, fishing hook 506, and retainer 510 to each other. Alternatively, fishing hook 506 and retainer 510 maybe inserted into molded material 508 after the substance forming molded material 508 hardens. For example, fishing hook 506 may be driven directly into molded material 508. As another example, the two or more helical coils integrated or arranged into a multi-helix configuration may be rotated and driven into molded material 508.

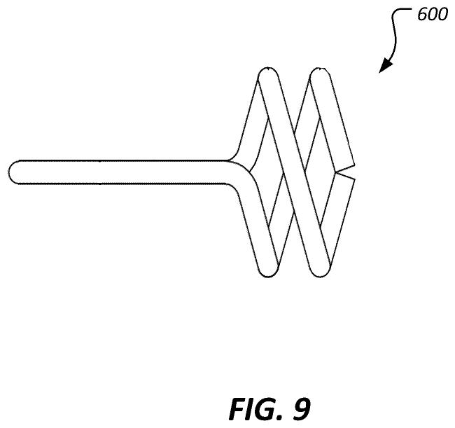

Referring now to FIG. 9, an alternative embodiment of a coupling member 600 is shown. The coupling member may generally comprise a similar overall length but with a shorter eye and with a longer coil. In some embodiments, the eye inner diameter may comprise a relatively thinner inner diameter and comprise an oval shape. In further alternative embodiments, such as larger coupling members, the overall length may be reduced and the number of coil turns may be reduced, such as, being reduced to as few as one or two complete coil turns about the lengthwise axis.

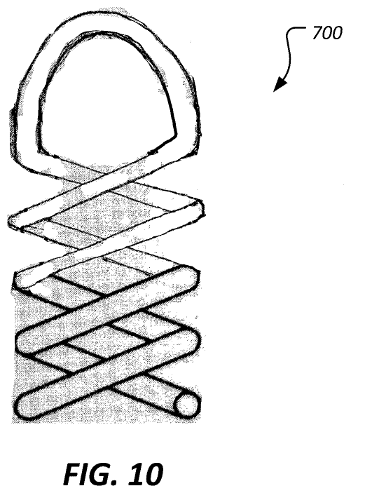

Referring now to FIG. 10, another alternative embodiment of a coupling member 700 is shown. The coupling member 700 comprises relatively longer transition members and relatively fewer coils about the longitudinal axis and/or a shorter overall longitudinal distance of coils.

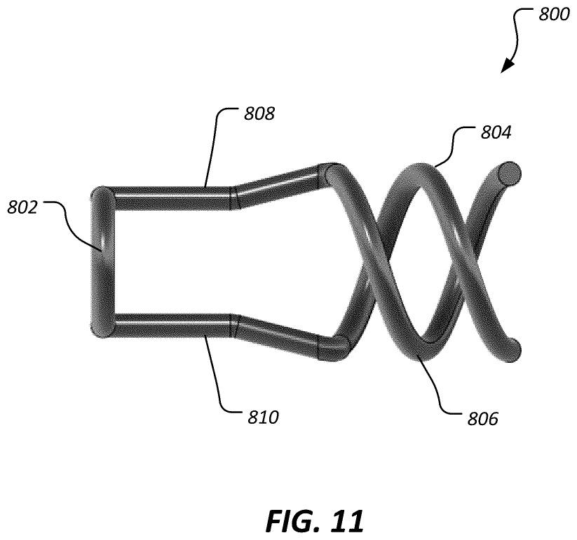

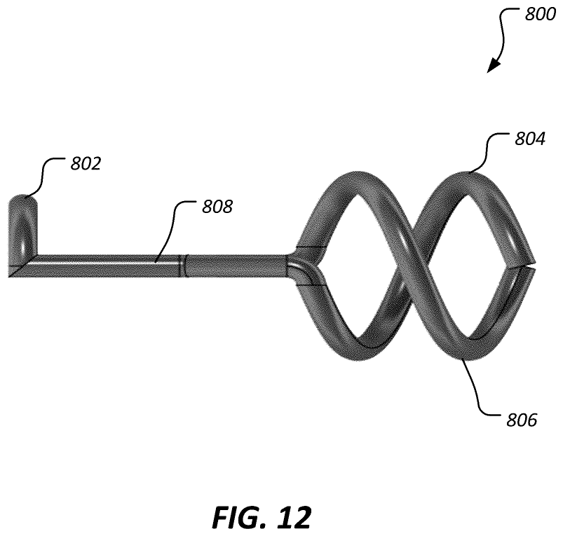

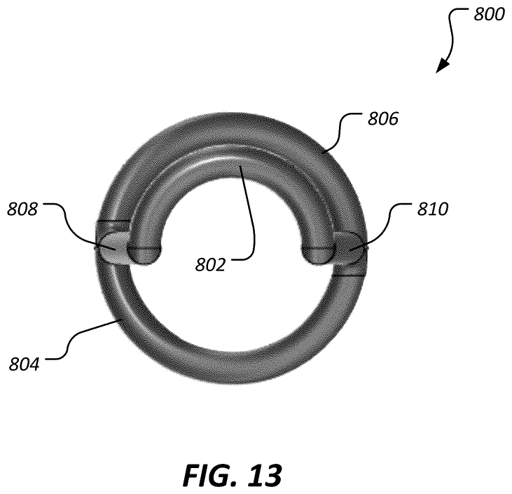

Referring now to FIGS. 11-13, an attachment device 800 is shown. Attachment device 800 can be substantially similar to attachment device 100, but with a primary difference being that attachment device 800 comprises a bent portion for embedding in a component, such as a lead head jig or molded material 508 such as those shown in FIGS. 6-8. Regardless of what the attachment device 800 is at least partially embedded within, device 800 comprises a bent embedded portion 802 bent substantially orthogonally relative to an axis about which one or more coils 804, 806 extend around. In alternative embodiment, the bent embedded portion can be shaped differently while still generally extending away from the central axis and providing an improved connection that resist removal of the device 800 when device 800 is urged away from the material into which the bent portion 802 is embedded or received. While the bent portion 802 is received by the material, the coils 804, 806 extend away from the material and allow insertion of the coils 804, 806 into a lure material or other tackle device.

It will be appreciated that one or more of the devices or systems described herein may be utilized with and/or incorporated into devices other than fishing lure systems. For example, the coupling members may be affixed to corkscrews, ground stake systems, or any other systems that can benefit from simultaneously embedding multiple coils into devices or materials such as corks of bottles, the earth, and/or any other object that can receive the coils and join the devices disclosed herein to the objects they are embedded into.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc .; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R|₁₊ₖ*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. An apparatus, comprising:
a coupling member configured to couple with a jig; and
a bent portion of an attachment device embedded within the coupling member, wherein the bent portion is connected to one or more helical coils that extend away from the coupling member.

2. A system, comprising:
a jig weight;
a fishing hook carried by the jig weight; and
a bent portion of an attachment device embedded within the coupling member, wherein the bent portion is connected to one or more helical coils that extend away from the coupling member.

3. The system of claim 2, wherein at least one of the helical coils are disposed around a portion of the fishing hook.

4. A system, comprising:
a jig;
a fishing hook carried by the jig; and
a bent portion of an attachment device embedded within the jig, wherein the bent portion is connected to one or more helical coils that extend away from the coupling member.

5. The system of claim 4, wherein at least one of the helical coils are disposed around a portion of the fishing hook.
